(19) United States
(12) Patent Application Publication
(10) Pub. No.: US 2022/0350607 A1
(43) Pub. Date: Nov. 3, 2022

(54) METHOD OF EXECUTING OPERATION, ELECTRONIC DEVICE, AND COMPUTER-READABLE STORAGE MEDIUM

(71) Applicant: KUNLUNXIN TECHNOLOGY (BEIJING) COMPANY LIMITED, Beijing (CN)

(72) Inventors: Yingnan XU, Beijing (CN); Xueliang DU, Beijing (CN)

(21) Appl. No.: 17/867,859

(22) Filed: Jul. 19, 2022

(30) Foreign Application Priority Data
Jul. 20, 2021 (CN) 202110820258.6

(51) Int. Cl. G06F 9/30; G06F 9/345; G06F 9/355; G06F 9/38

(52) U.S. Cl. CPC G06F 9/30036; G06F 9/345; G06F 9/3555; G06F 9/3836

(57) ABSTRACT

A method of executing an operation in a deep learning training, an electronic device, and a computer-readable storage medium, which relate to a field of artificial intelligence, especially to a field of deep learning. The method of executing an operation in a deep learning training includes: acquiring an instruction for the operation including a plurality of vector operations; determining, for each vector operation of the plurality of vector operations, two source operand vectors for a comparison; and executing the vector operation on the two source operand vectors using an instruction format for the vector operation, so as to obtain an operation result including a destination operand vector.

### CROSS REFERENCE TO RELATED APPLICATION(S)

This application claims priority to Chinese Patent Application No. 202110820258.6, filed on Jul. 20, 2021, the entire content of which is incorporated herein in its entirety by reference.

### TECHNICAL FIELD

The present disclosure relates to a field of a computer technology, in particular to a method of executing an operation, an electronic device, and a computer-readable storage medium, which may be used in a field of artificial intelligence, especially in a field of deep learning.

### BACKGROUND

With a wide application of deep learning training, people put forward higher and higher requirements to improve a speed of deep learning training. Various operations in the deep learning training may involve a scalar operation, a vector operation, etc. In a deep learning algorithm, a complex operation, such as a tensor operation, is usually performed for various application scenarios. The tensor operation may be decomposed into multiple continuous vector operations using a compiler. A lot of computing resources are consumed for executing these vector operations. As a result, it is difficult to process a large number of vector operations in time, and even causes the system for deep learning training to quit the execution of the operation due to insufficient computing resources. Therefore, an efficiency of a large number of continuous vector operations should be improved, so as to improve a speed of the whole deep learning training.

### SUMMARY

The present disclosure provides a method of executing an operation, an electronic device, and a computer-readable storage medium.

According to an aspect of the present disclosure, a method of executing an operation in a deep learning training is provided, including:

acquiring an instruction for the operation, the operation including a plurality of vector operations;

determining, for each vector operation of the plurality of vector operations, two source operand vectors for a comparison; and

executing the vector operation on the two source operand vectors using an instruction format for the vector operation, so as to obtain an operation result including a destination operand vector.

According to an aspect of the present disclosure, an electronic device is provided, including: at least one processor; and a memory communicatively connected to the at least one processor, wherein the memory stores instructions executable by the at least one processor, and the instructions, when executed by the at least one processor, cause the at least one processor to implement the method of the present disclosure described above.

According to an aspect of the present disclosure, a non-transitory computer-readable storage medium having computer instructions therein is provided, wherein the computer instructions are configured to cause a computer to implement the method of the present disclosure described above.

It should be understood that content described in this section is not intended to identify critical or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, wherein:

FIG. 1 shows a schematic block diagram of a deep learning training environment 100 in which a method of executing an operation of some embodiments of the present disclosure may be implemented;

FIG. 2 shows a flowchart of an operation method 200 according to embodiments of the present disclosure;

FIG. 3 shows a flowchart of an operation method 300 according to embodiments of the present disclosure;

FIG. 4 shows a schematic diagram of accelerating a vector operation according to embodiments of the present disclosure;

FIG. 5 shows a scenario diagram of executing continuous vector operations according to embodiments of the present disclosure;

FIG. 6 shows a block diagram of an apparatus 600 of executing an operation according to embodiments of the present disclosure;

FIG. 7 shows a schematic block diagram of a chip 700 for executing an operation according to embodiments of the present disclosure; and

FIG. 8 shows a block diagram of an electronic device 800 for implementing a method of executing an operation according to embodiments of the present disclosure.

### DETAILED DESCRIPTION OF EMBODIMENTS

Exemplary embodiments of the present disclosure will be described below with reference to the accompanying drawings, which include various details of embodiments of the present disclosure to facilitate understanding and should be considered as merely exemplary. Therefore, those of ordinary skilled in the art should realize that various changes and modifications may be made to embodiments described herein without departing from the scope and spirit of the present disclosure. Likewise, for clarity and conciseness, descriptions of well-known functions and structures are omitted in the following description.

As described in the background above, with the wide application of deep learning training, people put forward higher and higher requirements to improve the speed of deep learning training Various operations in the deep learning algorithm may involve the scalar operation, the vector operation, etc. An existing tensor operation in the deep learning algorithm may be decomposed into multiple continuous vector operations. These vector operations involve computation for SETcc (condition code) operation. For example, SETlt and SETgt each belong to a type of SETcc operation, a main operation of the SETcc operation are shown in Table 1 below.

TABLE 1
SETcc operation

```
Operation
condition = Source Operand 0 condition code Source Operand 1
IF condition THEN
  Destination Operand is set to 1;
ELSE
  Destination Operand is set to 0;
```

In the SETcc operation, the destination operand is set to 0 or 1 of a data type according to a result of comparing values of two source operands. The data type of the destination operand is consistent with the data type of the source operands. Element-Wise (EW) comparison operation is a common operation in a deep learning algorithm. In a process of training the algorithm, both SETlt and SETgt are used in a reverse gradient computation of the EW comparison operation. Table 2 below shows algorithms of the common EW comparison operation.

TABLE 2
EW algorithms

Element-Wise MIN/MAX forward algorithm
If x < y, an operation result of x < y is set as target z
Element-Wise MIN/MAX backward algorithm
Increments dx and dy are computed according to an operation result of x < y

In the deep learning training, it is possible to consider how to accelerate a vector operation in an acceleration unit of a reverse training algorithm in an artificial intelligence (AI) chip processor, so as to improve a computation speed of the deep learning training process. When there are a large number of operations, the speed of computing these operations has become a main limitation of a computing ability of the artificial intelligence chip processor. In the deep learning training, the executions of a large number of vector operations usually require a large amount of computing resources. As a result, it is difficult to process a large number of vector operations in time, and even causes the system for deep learning training to quit the executions of these operations due to insufficient computing resources. Furthermore, main deep learning algorithms in existing technologies have some problems in dealing with a large number of vector operations. For example, vector acceleration units of existing CPU and GPU processors do not support the SETcc instruction. When the training of the deep learning algorithm involves the SETcc operation, two solutions are generally adopted: (1) one is to use a scalar unit to perform a serialization operation, and (2) the other is to accelerate by starting multiple cores in parallel. The solution (1) is usually used in a CPU processor of an intel/ARM manufacturer. This kind of processor usually includes a small number of cores. In view of a programming model, it is not suitable to execute the same algorithm kernel on multiple processor cores at the same time. Therefore, it is only possible to perform serial processing by using the scalar processing unit of each core. The serial processing consumes a relatively long time, and a delay of the serial processing is N (e.g., 8 or 16) times that of a parallel processing. The solution (2) is usually used in a GPU processor. GPU has a larger number of threads. In view of a programming model, it tends to divide a task onto multiple threads for execution. Different from the serial processing, the speed is improved. However, there is a problem of large overhead for synchronization between threads. Therefore, existing technologies have insufficient utilization degree of the chip processor, which results in a low performance-power consumption ratio of the chip processor, thereby affecting the efficiency of the deep learning.

In order to at least partially solve at least one of the above problems and other potential problems, embodiments of the present disclosure propose a solution of executing an operation in a deep learning training In the solution, by vectorizing an instruction for the operation, a parallelism for the operation is increased, and a computing speed of the operation is improved. Furthermore, as a plurality of vector operations are executed simultaneously, the inefficiency of CPU serialization processing is avoided. In addition, threads are not required to synchronize the completion of the same computing task, which may avoid the synchronization overhead of GPU processing. By using the technical solution of the present disclosure, the artificial intelligence chip processor is effectively utilized, so as to effectively improve the speed of the deep learning training.

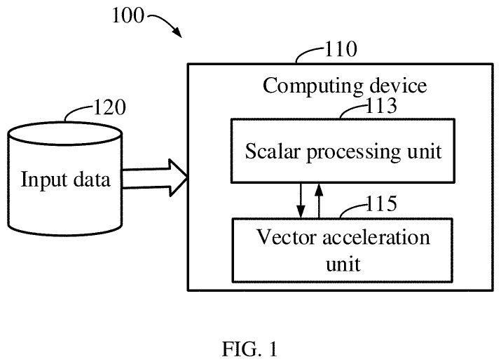

FIG. 1 shows a schematic block diagram of a deep learning training environment 100 in which a method of executing an operation of some embodiments of the present disclosure may be implemented. According to one or more embodiments of the present disclosure, the deep learning training environment 100 may be a cloud environment. As shown in FIG. 1, the deep learning training environment 100 includes a computing device 110. In the deep learning training environment 100, input data 120 is provided to the computing device 110 as an input to the computing device 110. The input data 120 may include, for example, data associated with an operation for deep learning, data associated with an instruction for an operation, and the like. As also shown in FIG. 1, the computing device 110 includes a scalar processing unit 113 and a vector acceleration unit 115.

According to one or more embodiments of the present disclosure, when an operation for deep learning needs to be executed, associated data is provided to the computing device 110 as input data 120. Then, the scalar processing unit 113 (also referred to as a core module) in the computing device 110 processes a basic scalar operation for the input data 120, and converts the input data 120 into a form of an instruction for the operation (e.g., SETcc instruction and vector SETcc instruction (vSETcc instruction), but the protection scope of the present disclosure is not limited to this), through operations such as instruction fetch (IF) and instruction decode (ID). The instruction for the operation may be processed by the arithmetic logic ALU and then written back to a memory of the scalar processing unit 113, or may be distributed to the vector acceleration unit 115 (also referred to as a vector acceleration module).

In embodiments of the present disclosure, based on a 32-bit instruction set of an existing architecture, an instruction vSETcc is newly proposed to support the operation on the input data 120. An instruction format is shown in Table 3. The design of the instruction format mainly involves: (1) compatibility and (2) extensibility. With respect to the compatibility, an independent opcode field is used to avoid affecting an existing instruction format. With respect to the extensibility, possible subsequent expansion requirements are fully considered on the instruction format, and a specific field is determined as a reserved field. It should be understood that the instruction vSETcc is taken as an example of implementing an operation, and those skilled in the art may use the content and spirit of the present disclosure to set instructions for implementing similar functions and new functions. As an example only, an implementation of vSETlt instruction is shown in Table 3.

TABLE 3
vSETcc instruction format
Instruction format: vSETlt
Function: for each element included in two vectors of floating point
type, the value of the destination operand is set by comparing the
values of the corresponding source operands in the two vectors

| | | | | | |
|---|---|---|---|---|---|
| Reserved | Second source | First source | Data type, supporting | Destination operand, | Opcode, determining |
| field | operand | operand | floating point, half | storing operation | whether the |
| | | | floating point, signed | result | condition code is |
| | | | integer, and unsigned | | “Less Than”, |
| | | | integer | | “Greater Than”, or |
| | | | | | “Equal” |

As shown in Table 3, in the vSETlt instruction, a specific field (for example, xfunct field) is used as the reserved field. It should be understood that other field may also be used as the reserved field for possible subsequent expansion requirements. As also shown in Table 3, in the opcode field, an opcode involves a specific vector operation. For example, the opcode is used to determine whether the condition code belongs to one of “an object is less than another object (Less Than)”, “an object is greater than another object (Greater Than)”, or “an object is equal to another object (Equal)”. In addition, Table 3 further shows the data types of supported vector data, such as floating point (float), half floating point (bfloat), signed integer (int), unsigned integer (unsigned int), etc. It should be understood that although the above data types are shown here only, other data types may also be used, such as 16 bit signed integer (short) represented by binary complement, 64 bit signed integer (long) represented by binary complement, double precision 64 bit floating point (double) conforming to IEEE 754 standard, single 16 bit Unicode character (char), boolean representing one bit information, etc.

In the vector acceleration unit 115, an instruction (e.g., SETcc instruction) for the operation is vectorized, so that a plurality of vector operations (also referred to as vectorization operations) are executed in parallel and continuously. The scalar processing unit 113 interacts with the vector acceleration unit 115 through a simple interface, which achieves the independence of module development to a certain extent and reduces the impact on existing processor units.

It should be understood that the deep learning training environment 100 is only exemplary and not restrictive, and the deep learning training environment 100 is extensible, which may include more computing devices 110, and may provide more input data 120 to the computing devices 110, so that more computing devices 110 may be utilized by more users at the same time, and even more input data 120 is used to simultaneously or non-simultaneously determine and execute a plurality of operations for deep learning. In addition, the computing device 110 may include other units, such as a data storage unit, an information preprocessing unit, and the like.

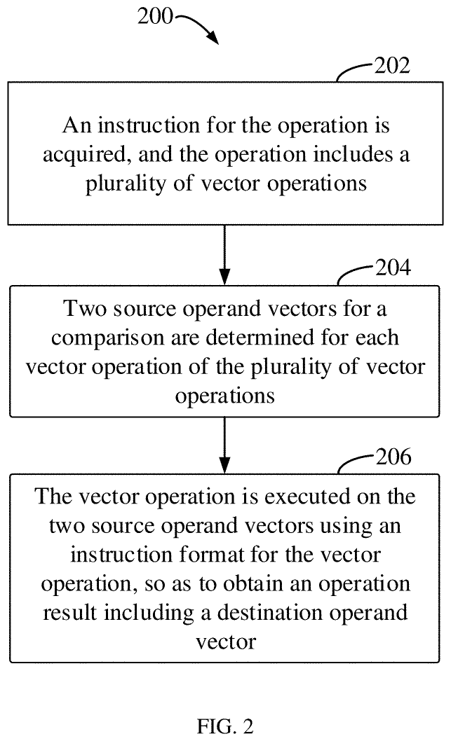

FIG. 2 shows a flowchart of a method 200 of executing an operation according to embodiments of the present disclosure. Specifically, the method 200 of executing an operation may be implemented by the computing device 110 in the deep learning training environment 100 shown in FIG. 1. It should be understood that the method 200 of executing an operation may further include additional operations not shown and/or the operations shown may be omitted, and the scope of the present disclosure is not limited in this regard.

At block 202, the computing device 110 acquires an instruction for the operation. The operation includes a plurality of vector operations. According to one or more embodiments of the present disclosure, the instruction for the operation may be the input data 120 or an instruction processed by the scalar processing unit 113 in the computing device 110.

At block 204, the computing device 110 determines, for each vector operation of the plurality of vector operations acquired at block 202, two source operand vectors for a comparison. According to one or more embodiments of the present disclosure, the source operands involved in each vector operation are distributed to vector register file (VRF), cache, or other types of temporary storage apparatuses according to a data type. As the purpose of the method 200 is to accelerate the operation under the framework of the existing chip processor, the problem to be solved is to reduce the delay of the serial processing scalar operation and reduce or avoid the synchronization overhead between different threads. In this case, the above-mentioned problem is solved in the method 200 by implementing the vectorization of the instruction for the operation and using, for example, the vSETcc instruction format.

At block 206, the computing device 110 executes the vector operation on the two source operand vectors using an instruction format for the vector operation, so as to obtain an operation result including a destination operand vector. According to one or more embodiments of the present disclosure, in the context of the present disclosure, the data to be operated, such as the data to be compared, are combined in a form of vectors, and a corresponding operation is executed for each element in the vectors. The process of obtaining the computation result is the vectorization operation or vector operation. By vectorizing the instruction for the operation, the parallelism for the operation is increased. This method may be implemented to improve the computation speed of the operation.

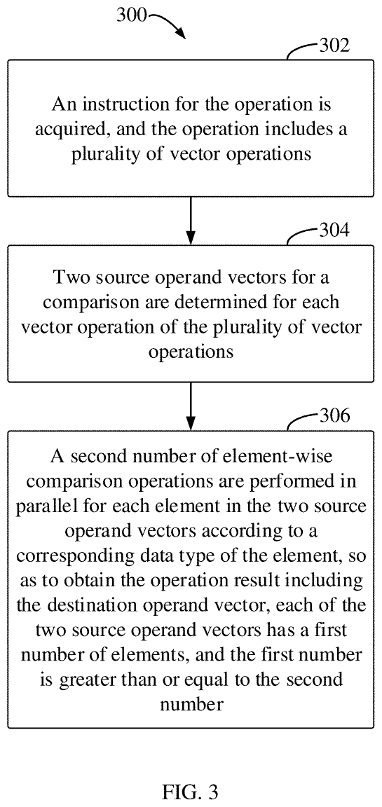

FIG. 3 shows a flowchart of a method 300 of executing an operation according to embodiments of the present disclosure. Specifically, the method 300 of executing an operation may also be implemented by the computing device 110 in the deep learning training environment 100 shown in FIG. 1. It should be understood that the method 300 of executing an operation may be taken as an extension of the method 200 of executing an operation, and the method may further include additional operations not shown and/or the operations shown may be omitted, and the scope of the present disclosure is not limited in this regard.

At block 302, the computing device 110 acquires an instruction for an operation. The operation includes a plurality of vector operations. Specific contents of the step involved in block 302 are the same as those involved in block 202, which will not be repeated here.

At block 304, the computing device 110 determines, for each vector operation of the plurality of vector operations acquired at block 302, two source operand vectors for a comparison. Specific contents of the step involved in block 304 are the same as those involved in block 204, which will not be repeated here.

At block 306, the computing device 110 performs, for each element in the two source operand vectors, a second number of element-wise comparison operations in parallel according to a corresponding data type of the element using an instruction format for the vector operation, so as to obtain the operation result including the destination operand vector. Each of the two source operand vectors has a first number of elements, and the first number is greater than or equal to the second number.

According to one or more embodiments of the present disclosure, the data to be operated, such as the data to be compared, are combined in a form of vectors, and two source operand vectors are thus obtained. The operation on the two source operand vectors will be better than an operation on source operands of two scalars, because elements of the same type are collectively processed. Each of the two source operand vectors has the first number of elements. Then, for each element in the two source operand vectors, a second number of element-wise comparison operations are performed in parallel according to a data type of the element. It should be understood that, for example, there may be a relatively small number of processors on a chip with limited resources, and thus, for the first number of elements to be operated, the number of element operations performed in the corresponding processing unit may be equal to or less than the number of the elements. For an element in the vectors on which no operation is performed, it is possible for that element to wait for the next parallel processing cycle in sequence. In other words, in the technical solution of the present disclosure, the number (i.e., the first number) of elements in the source operand vector may be greater than or equal to the number (i.e., the second number) of performed vector operations. Therefore, the technical solution of the present disclosure may be used not only on a next generation chip processor with powerful computing function, but also on an existing chip processor with limited resources so as to improve the utilization degree of the existing chip processor.

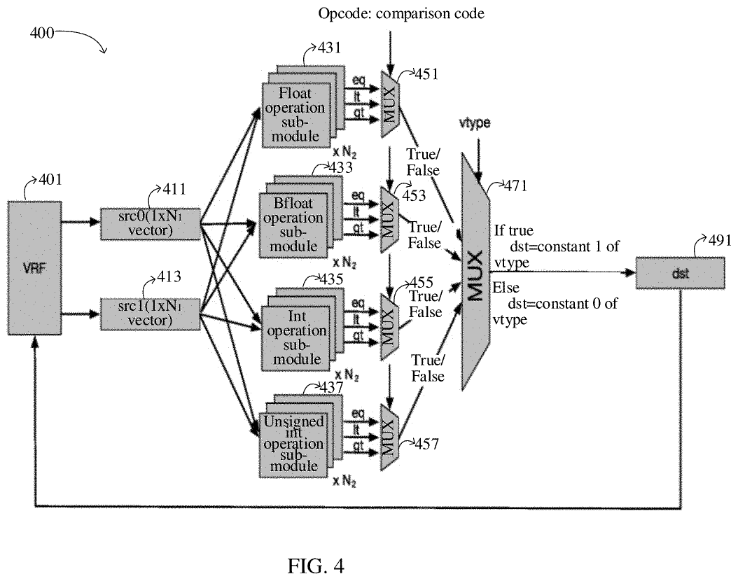

FIG. 4 shows a schematic diagram of a process 400 of accelerating a vector operation according to embodiments of the present disclosure. According to one or more embodiments, as shown in FIG. 4, the execution of the vector operation begins with loading data from a memory into a corresponding source operand register file VRF (401). After the operands are prepared, the operands are transmitted to at least one of comparison sub-modules (431, 433, 435 and 437) for operation, and the operation result is finally written back (stored) into the storage space. It should be understood that for some reusable data, the process of loading from the memory may be omitted.

As shown in FIG. 4, each of the source operand vectors src0 (1×N₁ vector) 411 and src1 (1×N₁ vector) 413 has a first number N₁ of elements. Each element in the source operand vectors src0 411 and src1 413 is distributed to one of a second number N₂ of operation sub-modules of the same data type (e.g., the float point data type) according to a data type of the element (e.g., the float point data type). For each of the source operand vectors src0 411 and src1 413, the number of elements participating in current element-wise comparison operations in parallel is N₂. For an element in the source operand vector src0 411 or src1 413 that has not been compared in current element-wise comparison operations, it is possible for that element to wait for the next parallel processing cycle in sequence. As mentioned above, for example, there may be a relatively small number of processors on a chip with limited resources. By setting the number N₂ of the comparison sub-modules that perform the element-wise comparison operations in parallel to be less than or equal to the number N₁ of the elements in the source operand vector, the chip processor may be used effectively according to the technical solution of the present disclosure, thereby effectively improving the training speed of the deep learning algorithm on the chip processor. Taking the float operation sub-module 431 as an example, the second number N₂ float operation sub-modules 431 receive elements of the float point data type from the source operand vector src0 411 and elements of the float point data type from the source operand vector src1 413, respectively. Each float operation sub-module 431 may compare an element of the float point data type in the source operand vector src0 411 with a corresponding element of the float point data type in the source operand vector src1 413. After the computation by the operation sub-modules 431 of the same data type (the float point data type), it is possible to determine, at a multiplexer (MUX for short) 451, whether the comparison result between the floating point element in src0 411 and the corresponding floating point element in src1 413 is true or false. It should be understood that the condition code for comparison may belong to one of “an object is less than another object (Less Than)”, “an object is greater than another object (Greater Than)”, or “an object is equal to another object (Equal)”. If the comparison result is true, a destination operand dst 491 is set to constant 1 of float point data type, otherwise the destination operand dst 491 is set to constant 0 of float point data type. If the data type is not determined at the source operand vector, a determination may be performed for the data type (vtype) at the multiplexer 471 after the comparison result is determined. If the data types are consistent, the destination operand dst 491 is set to constant 1 of that data type, otherwise the destination operand dst 491 is set to constant 0 of that data type.

According to one or more embodiments of the present disclosure, as the comparison sub-modules of each data type perform operations for elements of all data types, it is valid to determine the specific data type after the comparison result is determined. It should be understood that the determination of the data type may also be performed at the source operand vector, so that it may be determined that only one type of comparison sub-modules is executed before the operation. In addition, it should be understood that the specific data types listed in FIG. 4 are shown only as examples and do not limit other possible data types.

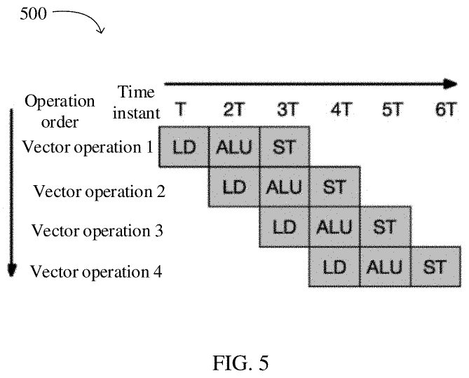

FIG. 5 shows a scenario diagram of executing continuous vector operations 500 according to embodiments of the present disclosure. As shown in FIG. 5, each vector operation of the continuous vector operations is not executed serially, but is executed in an order of loading (LD), ALU operation, and storing (ST). Executions of two adjacent vector operations among the continuous vector operations partially overlap each other. In practice, by implementing the executions of the continuous vector operations, and combining with the parallel executions of the element-wise comparison operations shown in FIG. 4, the technical solution of the present disclosure has a significant progress in processing a large number of complex operations compared with existing CPU processors and GPU processors. This not only reduces the delay of serial processing, but also avoids the problem of large synchronization overhead between threads in parallel processing.

With reference to FIGS. 1 to 5, the related contents of the deep learning training environment 100 in which the method of executing the operation of some embodiments of the present disclosure may be implemented, the method 200 of executing an operation according to embodiments of the present disclosure, the method 300 of executing an operation according to embodiments of the present disclosure, the process of accelerating a vector operation according to embodiments of the present disclosure, and executing continuous vector operations according to embodiments of the present disclosure are described above. It should be understood that the above description is intended to better present the contents recorded in the present disclosure, and is not limited in any way.

It should be understood that the number of various elements and the size of physical quantities in the description with reference to accompanying drawings of the present disclosure are only examples, and are not limitations on the scope of protection of the present disclosure. The above number and size may be arbitrarily set as required without affecting the normal implementation of embodiments of the present disclosure.

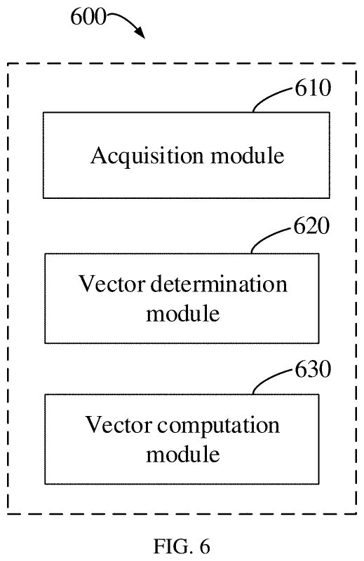

The details of the method 200 of executing an operation and the method 300 of executing an operation according to embodiments of the present disclosure have been described above with reference to FIGS. 1 to 5. Hereinafter, various modules in an apparatus of executing an operation will be described with reference to FIG. 6.

FIG. 6 shows a block diagram of an apparatus 600 of executing an operation according to embodiments of the present disclosure. As shown in FIG. 6, the apparatus 600 of executing an operation includes: an acquisition module 610, a vector determination module 620, and a vector computation module 630. The acquisition module 610 is used to acquire an instruction for the operation, the operation including a plurality of vector operations. The vector determination module 620 is used to determine, for each vector operation of the plurality of vector operations, two source operand vectors for a comparison. The vector computation module 630 is used to execute the vector operation on the two source operand vectors using an instruction format for the vector operation, so as to obtain an operation result including a destination operand vector.

In one or more embodiments, each of the two source operand vectors has a first number of elements, and executing the vector operation on the two source operand vectors includes: performing, for each element in the two source operand vectors, a second number of element-wise comparison operations in parallel according to a corresponding data type of the element, wherein the first number is greater than or equal to the second number.

In one or more embodiments, the executing the vector operation on the two source operand vectors further includes: determining a value of a corresponding element in the destination operand vector.

In one or more embodiments, the instruction format includes a field for the two source operand vectors, a field for the destination operand vector, a field for a data type, an opcode field, and/or a reserved field.

In one or more embodiments, an opcode in the opcode field includes one of: comparing whether an object is less than another object or not; comparing whether an object is greater than another object or not; or comparing whether an object is equal to another object or not.

In one or more embodiments, the data type of the destination operand vector includes one of: floating point, half floating point, signed integer, or unsigned integer.

In one or more embodiments, each vector operation of the plurality of vector operations is executed in an order of loading, ALU operation, and storing; and executions of two adjacent vector operations among the plurality of vector operations partially overlap each other.

Through the above description with reference to FIGS. 1 to 6, the technical solution according to embodiments of the present disclosure has many advantages over existing solutions. For example, in the technical solution according to embodiments of the present disclosure, by vectorizing the instruction for the operation, the parallelism for the operation may be increased, which achieves the executions of element-wise comparison operations in parallel for continuous vector operations. The technical solution of the present disclosure may be implemented to effectively improve the computation speed of deep learning training.

In the technical solution of the present disclosure, the collection, storage, use, processing, transmission, provision, disclosure and application of the user's personal information involved are all in compliance with the provisions of relevant laws and regulations, and necessary confidentiality measures have been taken, and it does not violate public order and good morals. In the technical solution of the present disclosure, before obtaining or collecting the user's personal information, the user's authorization or consent is obtained.

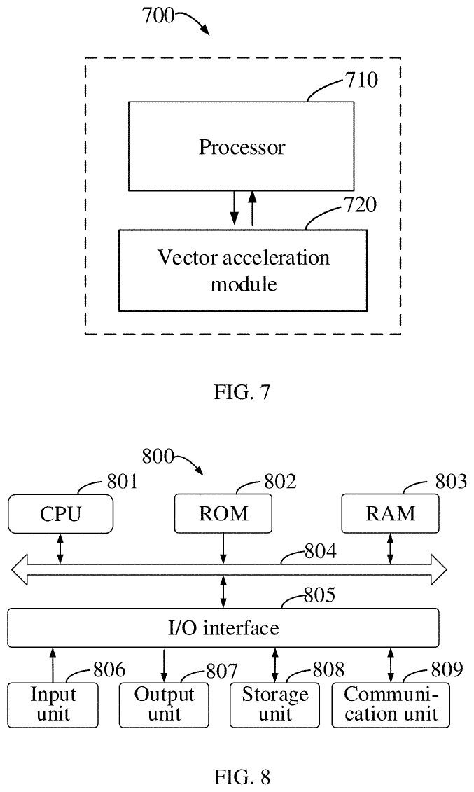

FIG. 7 shows a schematic block diagram of a chip 700 for executing an operation according to embodiments of the present disclosure. As shown in FIG. 7, the chip 700 for executing an operation may include a processor 710 and a vector acceleration module 720. The processor 710 converts input data into a form of an instruction for the operation through operations such as instruction fetch and instruction decode, and distributes the form of the instruction to the vector acceleration module 720. Similarly, the vector acceleration module 720 may also return an accelerated vector operation result to the processor 710. It should be understood that the chip 700 may include a plurality of processors 710 and a plurality of vector acceleration modules 720, and the vector acceleration module 720 may be the apparatus 600 shown in FIG. 6 or a combination of a plurality of apparatuses. It should also be understood that the chip 700 may be separately operated or may be added to other existing hardware architectures in combination, thereby speeding up the operation speed of the chip and improving the utilization degree of hardware systems including the chip.

According to embodiments of the present disclosure, the present disclosure further provides an electronic device, a readable storage medium, and a computer program product.

FIG. 8 shows a schematic block diagram of an exemplary electronic device 800 for implementing embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 8, the electronic device 800 may include a computing unit 801, which may perform various appropriate actions and processing based on a computer program stored in a read-only memory (ROM) 802 or a computer program loaded from a storage unit 808 into a random access memory (RAM) 803. Various programs and data required for the operation of the electronic device 800 may be stored in the RAM 803. The computing unit 801, the ROM 802 and the RAM 803 are connected to each other through a bus 804. An input/output (I/O) interface 805 is further connected to the bus 804.

Various components in the electronic device 800, including an input unit 806 such as a keyboard, a mouse, etc., an output unit 807 such as various types of displays, speakers, etc., a storage unit 808 such as a magnetic disk, an optical disk, etc., and a communication unit 809 such as a network card, a modem, a wireless communication transceiver, etc., are connected to the I/O interface 805. The communication unit 809 allows the electronic device 800 to exchange information/data with other devices through a computer network such as the Internet and/or various telecommunication networks.

The computing unit 801 may be various general-purpose and/or special-purpose processing components with processing and computing capabilities. Some examples of the computing unit 801 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, and so on. The computing unit 801 may perform the method and processing described above, such as the method 200 and the method 300. For example, in some embodiments, the method 200 and the method 300 may be implemented as a computer software program that is tangibly contained on a machine-readable medium, such as the storage unit 808. In some embodiments, part or all of a computer program may be loaded and/or installed on the electronic device 800 via the ROM 802 and/or the communication unit 809. When the computer program is loaded into the RAM 803 and executed by the computing unit 801, one or more steps of the method 200 and the method 300 may be performed. Alternatively, in other embodiments, the computing unit 801 may be configured to perform the method 200 and the method 300 in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may transmit the data and instructions to the storage system, the at least one input device, and the at least one output device.

Program codes for implementing the method of the present disclosure may be written in any combination of one or more programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or the server.

In the context of the present disclosure, the machine readable medium may be a tangible medium that may contain or store programs for use by or in combination with an instruction execution system, device or apparatus. The machine readable medium may be a machine-readable signal medium or a machine-readable storage medium. The machine readable medium may include, but not be limited to, electronic, magnetic, optical, electromagnetic, infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with users, the systems and techniques described here may be implemented on a computer including a display device (for example, a CRT (cathode ray tube) or LCD (liquid crystal display) monitor) for displaying information to the user), and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, and the server may also be a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of executing an operation in a deep learning training, comprising:
acquiring an instruction for the operation, the operation comprising a plurality of vector operations;
determining, for each vector operation of the plurality of vector operations, two source operand vectors for a comparison; and
executing the vector operation on the two source operand vectors using an instruction format for the vector operation, so as to obtain an operation result comprising a destination operand vector.

2. The method according to claim 1, wherein each of the two source operand vectors has a first number of elements, and the executing the vector operation on the two source operand vectors comprises:
performing, for each element in the two source operand vectors, a second number of element-wise comparison operations in parallel according to a data type of the element, wherein the first number is greater than or equal to the second number.

3. The method according to claim 2, further comprising:
determining a value of a corresponding element in the destination operand vector.

4. The method according to claim 1, wherein the instruction format comprises a field for the two source operand vectors, a field for the destination operand vector, a field for a data type, an opcode field, and/or a reserved field.

5. The method according to claim 4, wherein an opcode in the opcode field comprises one of: comparing whether an object is less than another object or not; comparing whether an object is greater than another object or not; or comparing whether an object is equal to another object or not.

6. The method according to claim 4, wherein the data type comprises one of: floating point, half floating point, signed integer, or unsigned integer.

7. The method according to claim 1, wherein each vector operation of the plurality of vector operations is executed in an order of loading, ALU operation, and storing; and executions of two adjacent vector operations among the plurality of vector operations partially overlap each other.

8. An electronic device, comprising:
at least one processor; and
a memory communicatively connected to the at least one processor, wherein the memory stores instructions executable by the at least one processor, and the instructions, when executed by the at least one processor, cause the at least one processor to:
acquire an instruction for the operation, the operation comprising a plurality of vector operations;
determine, for each vector operation of the plurality of vector operations, two source operand vectors for a comparison; and
execute the vector operation on the two source operand vectors using an instruction format for the vector operation, so as to obtain an operation result comprising a destination operand vector.

9. The electronic device according to claim 8, wherein each of the two source operand vectors has a first number of elements, and wherein the at least one processor is further configured to:
perform, for each element in the two source operand vectors, a second number of element-wise comparison operations in parallel according to a data type of the element, wherein the first number is greater than or equal to the second number.

10. The electronic device according to claim 9, wherein the at least one processor is further configured to:
determine a value of a corresponding element in the destination operand vector.

11. The electronic device according to claim 8, wherein the instruction format comprises a field for the two source operand vectors, a field for the destination operand vector, a field for a data type, an opcode field, and/or a reserved field.

12. The electronic device according to claim 11, wherein an opcode in the opcode field comprises one of: comparing whether an object is less than another object or not; comparing whether an object is greater than another object or not; or comparing whether an object is equal to another object or not.

13. The electronic device according to claim 11, wherein the data type comprises one of: floating point, half floating point, signed integer, or unsigned integer.

14. The electronic device according to claim 8, wherein each vector operation of the plurality of vector operations is executed in an order of loading, ALU operation, and storing; and executions of two adjacent vector operations among the plurality of vector operations partially overlap each other.

15. A non-transitory computer-readable storage medium having computer instructions therein, wherein the computer instructions are configured to cause a computer to:
acquire an instruction for the operation, the operation comprising a plurality of vector operations;
determine, for each vector operation of the plurality of vector operations, two source operand vectors for a comparison; and
execute the vector operation on the two source operand vectors using an instruction format for the vector operation, so as to obtain an operation result comprising a destination operand vector.

16. The non-transitory computer-readable storage medium according to claim 15, wherein each of the two source operand vectors has a first number of elements, and wherein the computer instructions are further configured to cause the computer to:
perform, for each element in the two source operand vectors, a second number of element-wise comparison operations in parallel according to a data type of the element, wherein the first number is greater than or equal to the second number.

17. The non-transitory computer-readable storage medium according to claim 16, wherein the computer instructions are further configured to cause the computer to:
determine a value of a corresponding element in the destination operand vector.

18. The non-transitory computer-readable storage medium according to claim 15, wherein the instruction format comprises a field for the two source operand vectors, a field for the destination operand vector, a field for a data type, an opcode field, and/or a reserved field.

19. The non-transitory computer-readable storage medium according to claim 18, wherein an opcode in the opcode field comprises one of: comparing whether an object is less than another object or not; comparing whether an object is greater than another object or not; or comparing whether an object is equal to another object or not.

20. The non-transitory computer-readable storage medium according to claim 18, wherein the data type comprises one of: floating point, half floating point, signed integer, or unsigned integer.
